(19) United States
(12) Patent Application Publication
(10) Pub. No.: US 2008/0013810 A1
(43) Pub. Date: Jan. 17, 2008

(54) IMAGE PROCESSING METHOD, COMPUTER READABLE MEDIUM THEREFOR, AND IMAGE PROCESSING SYSTEM

(75) Inventor: Kazuhiko Matsumoto, Tokyo (JP)

Correspondence Address: PEARNE & GORDON LLP, 1801 EAST 9TH STREET, SUITE 1200, CLEVELAND, OH, 44114-3108, US

(73) Assignee: Ziosoft, inc., Tokyo (JP)

(21) Appl. No.: 11/775,022

(22) Filed: Jul. 9, 2007

(30) Foreign Application Priority Data
Jul. 12, 2006 (JP) 2006-191665

(51) Int. Cl. G06K 9/00

(52) U.S. Cl. 382/128; 345/424; 382/131

(57) ABSTRACT

For a first client terminal to suspend image processing, the first client terminal transfers first creation condition parameters, independent parameters and first dependent parameters which are a task property to a data server for storing the parameters, and discards a first volume data, which is the task result. In the next phase, when a second client terminal continues the image processing, the second client terminal downloads slice data and the first creation condition parameters, the independent parameters and the first dependent parameters of the task property from the data server. The second client terminal converts the first creation condition parameters and the first dependent parameters into second creation condition parameters and second dependent parameters or creates the second creation condition parameters and the second dependent parameters, in response to the performance of the second client terminal, and creates second volume data.

This application claims foreign priority based on Japanese Patent application No. 2006-191665, filed Jul. 12, 2006, the contents of which are incorporated herein by reference in its entirety.

### BACKGROUND OF THE INVENTION

1. Field of the Invention

This invention relates to an image processing method, computer readable medium for image processing and image processing system, and in particular to an image processing method capable of continuing image processing even in a case where volume data to be used varies depending on performance of a client terminal.

2. Description of the Related Art

Hitherto, a three-dimensional image data as a volume data is obtained by a CT (computed tomography) apparatus, an MRI (magnetic resonance imaging) apparatus, etc. Volume data shall be projected in any desired direction to obtain a projection image. Volume rendering is widely used as image processing for obtaining such a projection image. As the volume rendering, for example, MIP (Maximum Intensity Projection) processing for extracting the maximum voxel value on a virtual ray relative to the projection direction to perform projection, MinIP (Minimum Intensity Projection) processing for extracting the minimum voxel value on a virtual ray to perform projection, a ray casting method of projecting a virtual ray in the projection direction and calculating a reflected light from an object, and the like are known.

FIGS. 18A-18C are schematic representations of a case where a client terminal starts image processing, then suspends processing and then resumes image processing. At step 1 shown in FIG. 18A, for a client terminal 92 to start image processing, the client terminal 92 downloads slice data from a data server 91 and creates volume data 93, and also creates a task property 94 corresponding to the volume data 93. The task property 94 is modified according to the task in the process in which the client terminal 92 performs image processing.

At step 2 shown in FIG. 18B, to suspend the image processing, the client terminal 92 transfers the task property 94 corresponding to the volume data 93 to the data server 91 for storing the task property. Then the volume data 93 as a subject of the task is discarded. The reason why the volume data is discarded is that the volume data itself is not modified during the task in many cases and may be again acquired when it again becomes necessary.

At step 3 shown in FIG. 18C, to resume the image processing, the client terminal 92 downloads the task property 94 and slice data from the data server 91, opens the task property 94, creates volume data 93 as same as that before the suspending of the client terminal 92, and continues the image processing. In the related art example, recovery of task intended for the same client terminal 92 is adopted as a case; however, if it can be operated under the same condition, recovery of task is possible even if the client terminal varies.

In this specification, the “client terminal” represents a computer for requesting an image processing server to perform image processing, such as a terminal operated by a user, and the “data server” represents a computer for storing slice data and task property. A “rendering server” represents a computer for performing image rendering (mainly, volume rendering) in response to a request of the client terminal.

The “slice data” represents tomographic images acquired directly from a CT apparatus, MRI apparatus or suchlike, and a plurality of slice data can be accumulated for providing three-dimensional representation. The “volume data” represents image data formed mainly by a three-dimensional array made up of the plurality of slice data, and when four-dimensional or more information exists, it is often operated in the form of holding a plurality of three-dimensional arrays.

FIGS. 19A-19C are drawings to describe problems of the related art technique for resuming the suspended image processing. At step 1 shown in FIG. 19A, for example, for a client terminal (1) 92 of a desktop personal computer to perform image processing, the client terminal (1) 92 downloads slice data from the data server 91 and creates volume data (1) 93 and task property 94 based on the memory capacity, etc., of the desktop personal computer.

At step 2 shown in FIG. 19B, to suspend the image processing, the client terminal (1) 92 transfers the task property 94 to the data server 91 and discards the volume data (1) 93 itself.

Then, at step 3 shown in FIG. 19C, for example, for a client terminal (2) 95 of a notebook personal computer to resume the image processing performed incompletely by the client terminal (1) 92, the client terminal (2) 95 downloads the task property 94 and slice data from the data server 91. At this time, the data size of the volume data is adjusted according to the performance of the computer used for calculation, and thus volume data (2) 96 created by the client terminal (2) 95 differs from the volume data (1) 93 and does not match with the task property 94 created by the client terminal (1) 92. Thus, the previous image processing cannot be continued.

That is, when the client terminal (1) 92 creates task property 94 by using its task state, even if the client terminal (2) 95 attempts to recover the task state by using the task property 94 created by the client terminal (1) 92, it becomes impossible to recover the task state when the volume data (2) 96 created by the client terminal (2) 95 differs from the volume data (1) 93.

Here, the “task state” is each parameters used in the internal program (process) of each client terminal. The “task property” is a collection of some parameters required for reconstructing an image among the parameters making up the “task state.” “Task property” can be serialized.

Thus, when the client terminals differ, the created volume data varies, since the data size of the volume data is adjusted according to the performance of the computer used for calculation. This means that when the client terminal changes, interpolation and/or reduction of data is changed, whereby the volume data changes. Particularly, it may be impossible to read volume data in the complete form because the memory amount is insufficient.

Additionally, when a combination of a fusion image is changed by the operation on the client terminal's side, the volume data changes. When image analysis processing or filtering is executed, the volume data also changes.

Either of the data server and the client terminal may execute image analysis processing and filtering, and the client terminal performs image processing using the volume data of the processing result. The client terminal holds the volume data of the processing result during the image processing, however, upon completion of the image processing, the volume data can be discarded.

### SUMMARY OF THE INVENTION

The present invention has been made in view of the above circumstances, and provides an image processing method, a computer readable medium for image processing and an image processing system capable of suspending and resuming image processing even if volume data to be used in calculation varies depending on performance of a client terminal.

In some implementations, an image processing method of the invention using volume data, said image processing method comprising:

creating first volume data from slice data based on a first creation condition parameter;

creating an independent parameter and a first dependent parameter from a task property for the first volume data;

obtaining a second dependent parameter from the first dependent parameter based on a second creation condition parameter and the first creation condition parameter;

creating second volume data from at least one of the slice data or data based on the slice data, based on the second creation condition parameter; and

creating a task property for the second volume data based on the independent parameter and the second dependent parameter.

According to the above configuration, for example, when the task property for the first volume data created in a first client terminal is used in a second client terminal of which performance is different from that of the first client terminal, the second dependent parameter that matches the second volume data created in the second client terminal is obtained, and the task property for the second volume data can be created. Thus, the image processing suspended during the task in the first client terminal can be resumed in the second client terminal. Therefore, even if the volume data to be used varies depending on the performance of the client terminal, the image processing can be suspended and resumed.

In the image processing method of the invention, the second volume data is created by changing a data size of the first volume data.

According to the above configuration, for example, even if the data size that can be processed in the second client terminal differs from that in the first client terminal, the second volume data and the second dependent parameter matching the performance of the second client terminal are created, whereby the image processing can be continued.

In the image processing method of the invention, at least one of the first volume data or the second volume data is created from a plurality of sets of said slice data used for making a fusion image.

In the image processing method of the invention, at least one of the first volume data or the second volume data is four-dimensional data.

In the image processing method of the invention, the first dependent parameter includes mask data.

In the image processing method of the invention, at least one rendering server is used for image rendering.

In the image processing method of the invention, at least one of the first volume data and the second volume data is subjected to distributed processing in a plurality of said rendering servers.

In some implementations, a computer readable medium of the invention having a program including instructions for permitting a computer to execute image processing for volume data, the instructions comprising:

creating first volume data from slice data based on a first creation condition parameter;

creating an independent parameter and a first dependent parameter from a task property for the first volume data;

obtaining a second dependent parameter from the first dependent parameter based on a second creation condition parameter and the first creation condition parameter;

creating second volume data from at least one of the slice data or data based on the slice data, based on the second creation condition parameter; and

creating a task property for the second volume data based on the independent parameter and the second dependent parameter.

In some implementations, an image processing system of the invention, comprising:

a data server for storing slice data; and

a first client terminal and a second client terminal,

wherein when the first client terminal is active and is to perform image processing, the first client terminal downloads the slice data from the data server so as to create first volume data based on first creation condition parameter, and creates an independent parameter and a first dependent parameter from a first task property for the first volume data,

the first client terminal transmits the first task property including the first creation condition parameter, the independent parameter and the first dependent parameter to the data server, before the first client terminal suspends processing, and

when the second client terminal is active and is to perform the image processing, the second client terminal downloads the slice data and the first task property including the first creation condition parameter, the independent parameter and the first dependent parameter to the data server, creates a second creation condition parameter and a second dependent parameter from the first creation condition parameter and the first dependent parameter according to performance of the second client terminal, creates second volume data from the slice data based on the second creation condition parameter, and creates a second task property for the second volume data based on the independent parameter and the second dependent parameter.

According to the image processing method, the computer readable medium and the image processing system according to the invention, even if the volume data to be used image processing varies depending on the performance of the client terminal, the image processing can be suspended and resumed.

### BRIEF DESCRIPTION OF THE DRAWINGS

In the accompanying drawings:

FIG. 1 is a drawing to schematically show a computed tomography (CT) apparatus used with an image processing method according to one embodiment of the invention;

FIG. 2 is a diagram (1) to describe the system configuration of an image processing apparatus according to the embodiment of the invention;

FIG. 3 is a drawing to describe classification of parameters in the image processing method of the embodiment;

FIGS. 4A-4C are drawings to show a processing flow (client terminal switching) wherein a client terminal (1) performs image processing and transfers the processing result to a data server and then a client terminal (2) resumes the image processing in the image processing method of the embodiment;

FIGS. 5A-5D are schematic representations concerning change in the number of slices of slice data;

FIGS. 6A-6D are schematic representations concerning matching of mask data corresponding to volume data;

FIGS. 7A-7D are drawings to describe an example of mismatch between volume data and mask data (a case where they differ in interpolation spacing);

FIGS. 8A-8D are drawings to describe an example of mismatch between volume data and mask data (a case where they differ in slice range);

FIGS. 9A-9D are drawings (1) to describe an example wherein mask data cannot easily be adjusted when a mismatch between volume data and mask data exists;

FIGS. 10A-10F are drawings (2) to describe an example wherein mask data cannot easily be adjusted when a mismatch between volume data and mask data exists;

FIGS. 11A-11F are drawings (3) to describe an example wherein mask data cannot easily be adjusted when a mismatch between volume data and mask data exists;

FIG. 12 is a schematic representation for creating a fusion image 60 from volume data 58 and 59 in the image processing method of the embodiment;

FIG. 13 is a diagram (2) to describe the system configuration of an image processing apparatus according to the embodiment of the invention;

FIGS. 14A and 14B are drawings to describe an image processing flow of the embodiment (rendering server switching);

FIGS. 15A and 15B are drawings to show example 1 wherein a plurality of three-dimensional arrays are retained when four-dimensional or more information exists in the image processing method of the embodiment;

FIGS. 16A and 16B are drawings to describe an image processing flow of the embodiment (for dealing with change of available rendering server);

FIGS. 17A and 17B are drawings to describe an image processing flow of the embodiment (for improving image precision of important part);

FIGS. 18A-18C are schematic representations of a case where a client terminal starts image processing and suspends, and then the same client terminal resumes the image processing; and

FIGS. 19A-19C are drawings to describe problems of a related art technique for resuming the suspended image processing.

### DESCRIPTION OF THE PREFERRED EMBODIMENTS

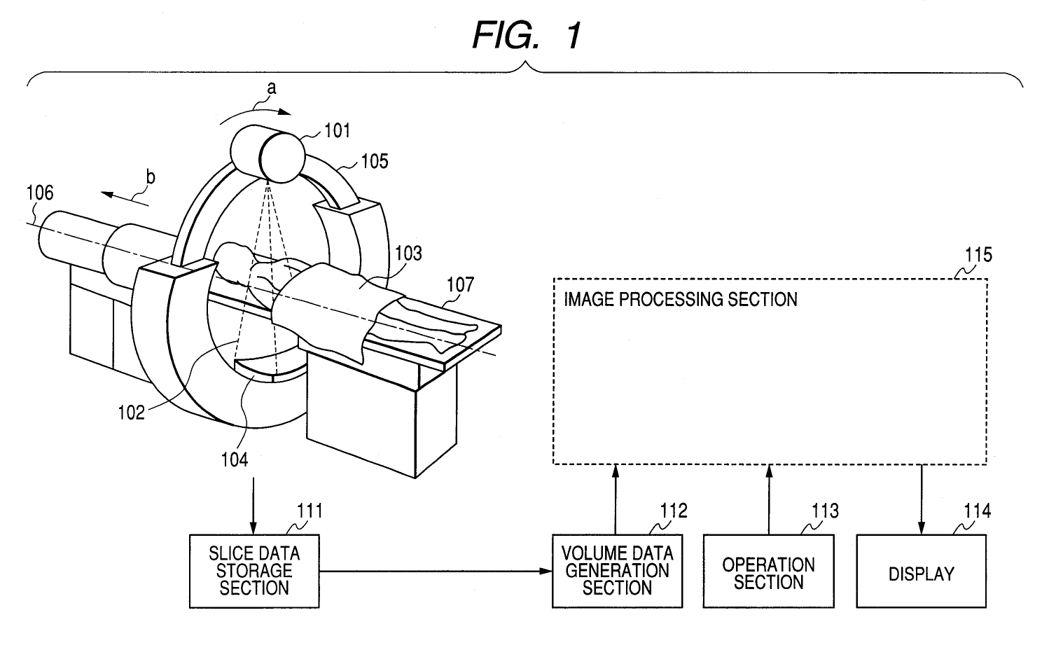

FIG. 1 schematically shows a computed tomography (CT) apparatus used with an image processing method and in an image processing system according to one embodiment of the invention. The computed tomography apparatus is used for visualizing tissues, etc., of a subject. A pyramid-like X-ray beam 102 having edge beams which is represented by dotted lines in FIG. 1 is emitted from an X-ray source 101. The X-ray beam 102 is applied on an X-ray detector 104 after transmitting through the subject, for example, a patient 103. In this embodiment, the X-ray source 101 and the X-ray detector 104 are disposed in a ring-like gantry 105 so as to face each other. The ring-like gantry 105 is supported by a retainer not shown in FIG. 1 so as to be rotatable (see the arrow “a”) about a system axis 106 which passes through the center point of the gantry.

In this embodiment, the patient 103 is lying on a table 107 through which the X-rays are transmitted. The table 107 is supported by a retainer which is not shown in FIG. 1 so as to be movable (see the arrow “b”) along the system axis 106.

Thus a CT system is configured so that the X-ray source 101 and the X-ray detector 104 are rotatable about the system axis 106 and movable along the system axis 106 relatively to the patient 103. Accordingly, X-rays can be cast on the patient 103 at various projection angles and in various positions with respect to the system axis 106. An output signal from the X-ray detector 104 when the X-rays are cast on the patient 103 are supplied to a slice data storage section 111.

In sequence scanning, the patient 103 is scanned in accordance with each sectional layer of the patient 103. When the patient 103 is scanned, while the X-ray source 101 and the X-ray detector 104 rotate around the patient 103 about the system axis 106 as its center, the CT system including the X-ray source 101 and the X-ray detector 104 captures a large number of projections to scan each two-dimensional sectional layer of the patient 103. A tomogram displaying the scanned sectional layer is reconstructed from the measured values acquired at that time. While the sectional layers are scanned continuously, the patient 103 is moved along the system axis 106 every time the scanning of one sectional layer is completed. This process is repeated until all sectional layers of interest are captured.

On the other hand, during spiral scanning, the table 107 moves along the direction of the arrow “b” continuously while the CT system including the X-ray source 101 and the X-ray detector 104 rotates about the system axis 106. That is, the CT system including the X-ray source 101 and the X-ray detector 104 moves on a spiral track continuously and relatively to the patient 103 until the region of interest of the patient 103 is captured completely. In this embodiment, signals of a large number of successive sectional layers in a diagnosing area of the patient 103 are supplied to the slice data storage section 111 as slice data by the computed tomography apparatus shown in FIG. 1.

The slice data stored in the slice data storage section 111 is supplied to a volume data generation section 112 and is generated as volume data. The volume data generated in the volume data generation section 112 is introduced into an image processing section 115 and is subjected to image processing.

The image created as the image processing section 115 performs image processing based on a setting by an operation section 113 is supplied to and displayed on a display 114. In addition to display of a volume rendering image, composite display of histograms, parallel display of a plurality of images, animation display of displaying a plurality of images in sequence, and display of a virtual endoscopic (VE) image are performed separately or simultaneously on the display 114.

The operation section 113 contains a GUI (Graphical User Interface), and sets a projection angle, an image type, coordinates, an LUT (look-up table), mask data, an LUT of fusion data, precision of ray casting, a center path of tubular tissue, region extraction of tissue, plane generation, and a display angle in spherical cylindrical projection, which are required by the image processing section 115, in response to operation signals from a keyboard, a mouse, etc. Accordingly, a user can interactively change the image and observe the lesion in detail while viewing the image displayed on the display 114.

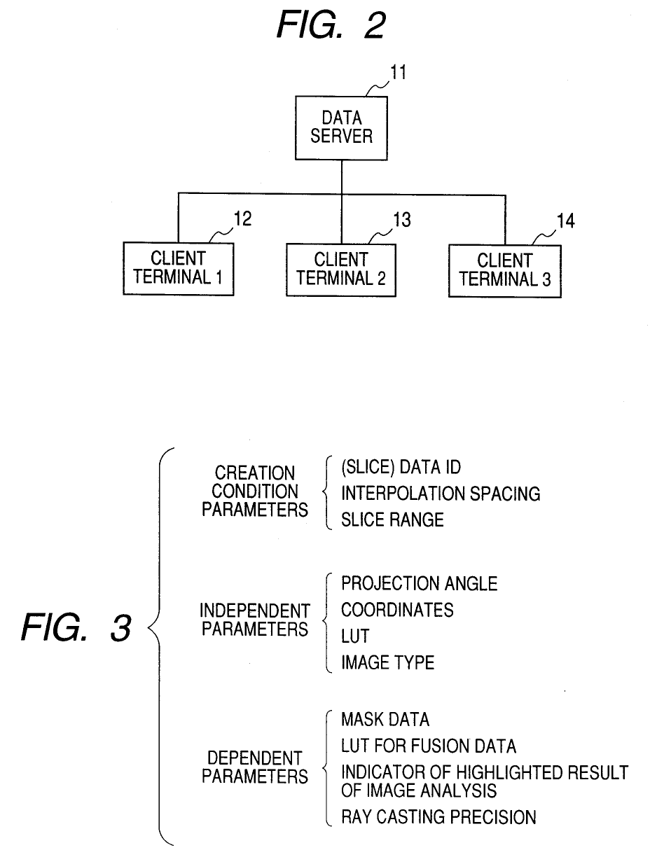

FIG. 2 is a diagram to describe the system configuration of an image processing apparatus according to the embodiment of the invention. The image processing system of the embodiment includes a data server 11, a client terminal (1) 12, a client terminal (2) 13, and a client terminal (3) 14. The client terminals (1) 12, (2) 13, and (3) 14 represent computers such as a terminal operated by a user for requesting the data server 11 to perform image processing, and the data server 11 represents a computer for storing slice data and task property. The client terminals (1) 12, (2) 13, and (3) 14 differ in performance respectively.

In the image processing method of the embodiment, for example, when the client terminal (1) 12 processes volume data 1 and the client terminal (2) 13 processes volume data 2, “independent parameters” and “dependent parameters” contained in task property are handled separately in the volume data 1 and the volume data 2.

The “independent parameters” are parameters that can be used independently of the client terminals (or client terminals performance), namely, can be used intact even if the client terminal (or client terminals performance) changes. The “dependent parameters” are parameters which are dependent on the client terminals (or client terminals performance), namely, required to be changed in response to change in the client terminal (or client terminal performance).

In the image processing method of the embodiment, the “dependent parameters” related to the volume data 1 are converted into a format that can be used with volume data 2 when the volume data 2 is opened. This conversion may be executed by any of the data server 11, the client terminal (1) 12 or (2) 13, and is executed at the same time of or before or after the creation of the volume data 2.

In the image processing method of the embodiment, as for the parameters that can be used only with the volume data 1 among the “dependent parameters”, parameters that can be used with the volume data 2 are newly created. The new parameters may be created by any of the data server 11, the client terminal (1) 12 or (2) 13, and are processed at a similar timing as image analysis processing or filtering.

FIG. 3 is a drawing to describe classification of the parameters contained in the task property in the image processing method of the embodiment. “Creation condition parameters” contain conditions for creating volume data from the slice data, such as a (slice) data ID, an interpolation spacing and a slice range (range of used slices). The data server or the client terminal creates volume data from the slice data (original data) according to the creation condition parameters, and processes the volume data at a similar timing as image analysis processing or filtering.

The “independent parameters” include the projection angle, the coordinates, the LUT (loop-up table), and the image type. The “dependent parameters” include the mask data, the LUT for fusion data, an indicator of highlighted result of image analysis, and the ray casting precision.

The “creation condition parameters” are the parameters required at the minimum for creating volume data of one type. These parameters are not classified into the “independent parameters” or the “dependent parameters”, and are specified each time the volume data is created.

That is, conversion of the dependent parameters is determined in accordance with the “creation condition parameters.” The “creation condition parameters” are specified based on the performance of the client terminal and by user's operation. To specify the “creation condition parameters,” the previous creation condition parameters can also be used.

Formerly, the parameters contained in the task property have been managed indivisibly, and thus after the “creation condition parameters” were once determined, they were not changed later and the “dependent parameters” were not changed either. Thus, when the client terminal was changed, the image processing had to be continued completely under the same conditions. Thus, when the client terminals differed in performance, the performance of the client terminal was insufficient or redundant for continuing the image processing completely under the same conditions. On the other hand, in the image processing method of the embodiment, conversion of the “dependent parameters” is determined in accordance with the “creation condition parameters,” so that even if the client terminal is changed, efficient image processing can be continued while conforming to the client terminal.

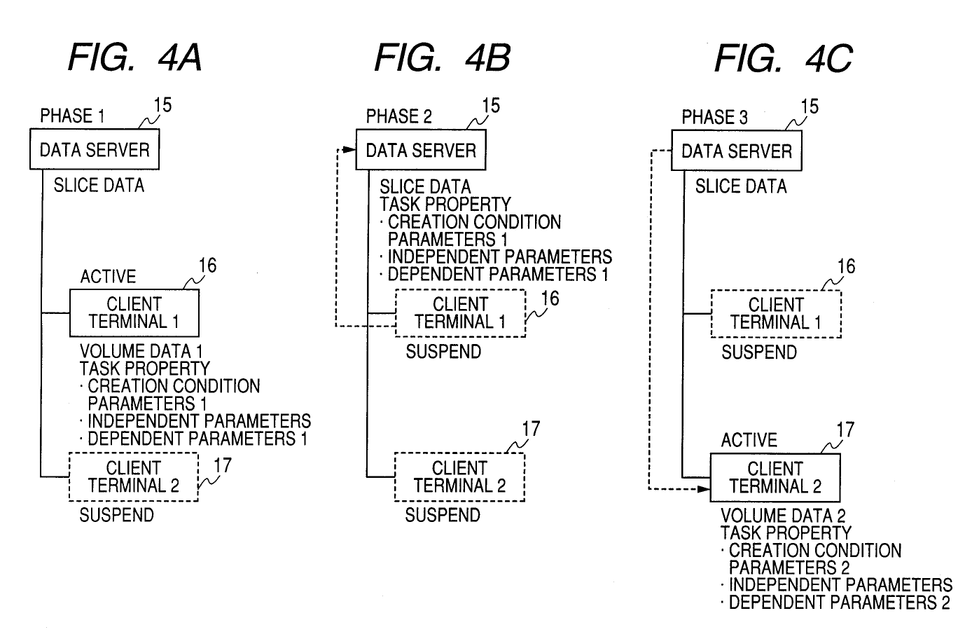

FIGS. 4A-4C show a processing flow (client terminal switching) wherein a client terminal (1) performs image processing and transfers the processing result to a data server as task property, and then a client terminal (2) resumes the image processing, in the image processing method of the embodiment.

In the image processing method of the embodiment, in phase 1 shown in FIG. 4A, a client terminal (2) 17 is suspended, and in a case where a client terminal (1) 16 performs image processing, the client terminal (1) 16 downloads the slice data from a data server 15 and creates volume data 1 in response to the performance of the client terminal (1) 16. The client terminal (1) 16 also creates creation condition parameters 1, independent parameters, and dependent parameters 1 as task property.

In phase 2 shown in FIG. 4B, for the client terminal (1) 16 to suspend the image processing, the client terminal (1) 16 transfers the creation condition parameters 1, the independent parameters, and the dependent parameters 1 of the task property to the data server 15 for storing the parameters, and discards the volume data 1 as the task result.

Next, in phase 3 shown in FIG. 4C, the client terminal (1) 16 suspends the image processing, and when the client terminal (2) 17 becomes active and continues the image processing, the client terminal (2) 17 downloads the slice data and the creation condition parameters 1, the independent parameters, and the dependent parameters 1 of the task property from the data server 15.

The client terminal (2) 17 converts the creation condition parameters 1 and the dependent parameters 1 into creation condition parameters 2 and dependent parameters 2 or creates creation condition parameters 2 and dependent parameters 2 in response to the performance of the client terminal (2) 17, and creates volume data 2.

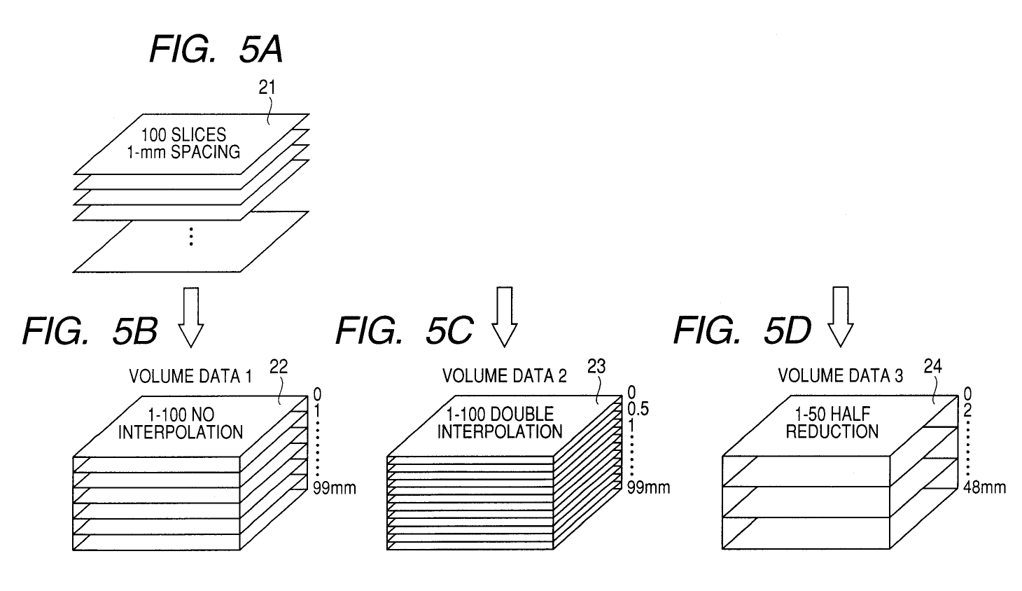

In this case, the client terminal (2) 17 uses the difference between the creation condition parameters 2 and the creation condition parameters 1 to create the dependent parameters 2 from the dependent parameters 1. The difference between the creation condition parameters 2 of the client terminal (2) 17 and the creation condition parameters 1 of the client terminal (1) 16 will be discussed as a specific example with FIGS. 5A-5D.

FIGS. 5A-5D are schematic representations concerning change in the data size of volume data. The volume data is provided by forming a set of slice data (two-dimensional data) acquired from a CT apparatus, etc., as a three-dimensional array. For example, slice data 21 (two-dimensional data) of 100 slices with 1-mm spacing as shown in FIG. 5A is stored in the data server, and the client terminal uses slice data of slices 1 to 100 to form volume data (1) 22 of a three-dimensional array of 99 mm with no interpolation in Z direction as shown in FIG. 5B.

The client terminal can also use the slice data of the slices 1 to 100 to create volume data (2) 23 of 99 mm with double interpolation in the Z direction to increase the data amount by interpolation as shown in FIG. 5C, and can also use the slices 1 to 50 as a part of the slice data to create volume data (3) 24 of 48 mm with half reduction in the Z direction to decrease the data amount by reduction as shown in FIG. 5D.

The number of slices corresponds to the slice range of the “creation condition parameters” as shown in FIG. 3, and the slice data 21 in FIG. 5A is numbered 1 to 100 because the number of slices is 100. In the volume data (3) 24 shown in FIG. 5D, the slices 1 to 50 in the slice data 21 are used. The data size also can be changed by other than the number of slices.

In this case, for example, the creation condition of the volume data (1) 22 shown in FIG. 5B is use of slices 1 to 100 and no interpolation, and the creation condition of the volume data (3) 24 shown in FIG. 5D is use of slices 1 to 50 and half reduction. Thus, the difference therebetween is used to create the dependent parameters. The processing of creating the dependent parameters may be performed by either of the data server and the client terminal, and is executed at a similar timing as in image analysis processing or filtering.

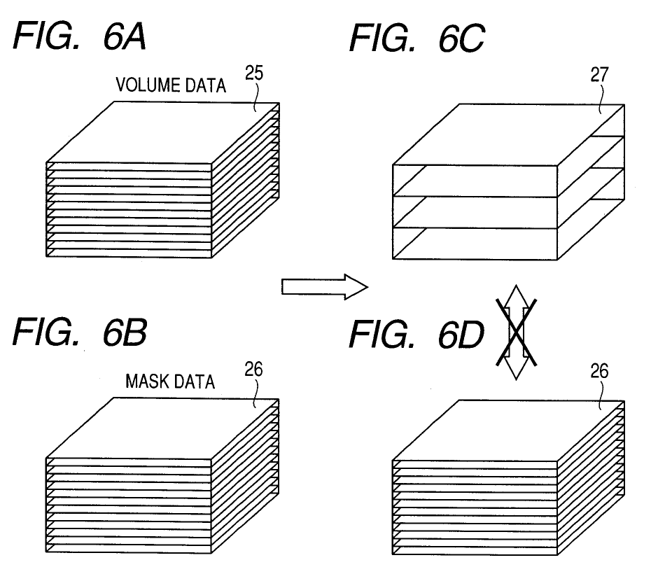

FIGS. 6A-6D are schematic representations concerning matching of mask data corresponding to volume data. FIG. 6A shows volume data 25, and FIG. 6B shows mask data 26 corresponding to the volume data 25. Since mask information of the mask data 26 is in a one-to-one correspondence with voxels of the volume data 25, when the volume data 25 changes to volume data 27 as shown in FIG. 6C, the volume data does not match with the mask data 26 (FIG. 6D).

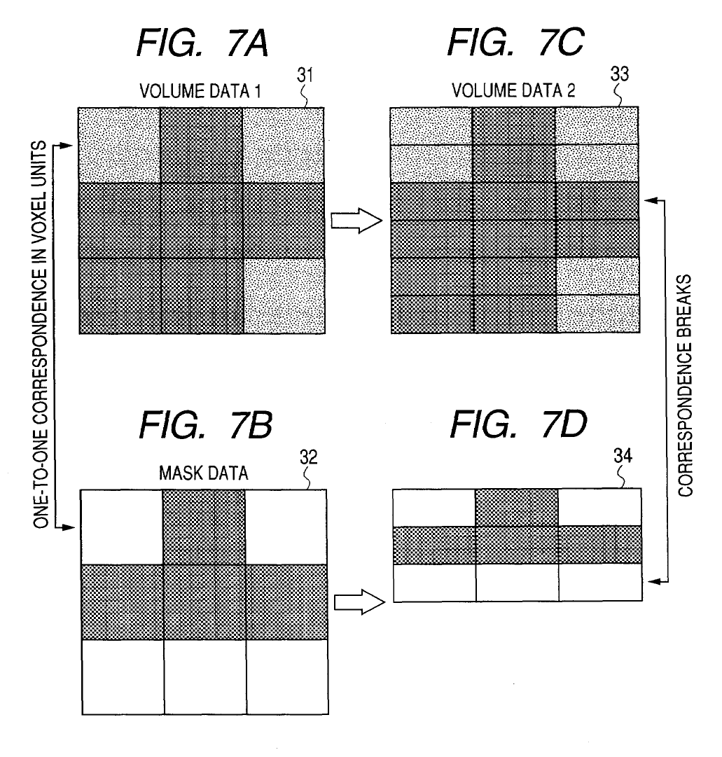

FIGS. 7A-7D are drawings to describe an example of mismatch between volume data and mask data (where they differ in interpolation spacing). FIG. 7A shows volume data (1) 31, and FIG. 7B shows mask data 32 corresponding to the volume data (1) 31. Since the mask data 32 is in a one-to-one correspondence with the volume data (1) 31 in voxel units, volume data (2) 33 which is different from the volume data (1) 31 in interpolation spacing as shown in FIG. 7C is placed out of the correspondence with mask data 34 (FIG. 7D). This is because a physical coordinate relationship is maintained between the volume data (1) and the volume data (2), but the logical coordinate relationship is not maintained therebetween although the volume data and the mask data are associated with each other based on the logical coordinates.

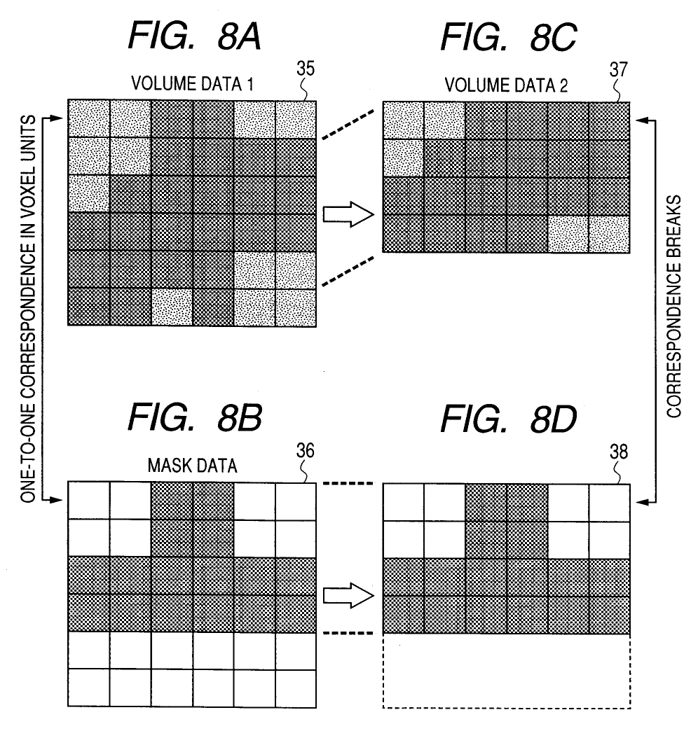

FIGS. 8A-8D are drawings to describe an example of mismatch between volume data and mask data (where they differ in slice range). FIG. 8A shows volume data (1) 35, and FIG. 8B shows mask data 36 corresponding to the volume data (1) 35. Since the mask data 36 is in a one-to-one correspondence with the volume data (1) 35 in voxel units, volume data (2) 37 which is different from the volume data (1) 35 in the slice range as shown in FIG. 8C is placed out of the correspondence with mask data 38 (FIG. 8D).

In the image processing method of the embodiment, when the data size of the volume data is changed, new mask data is created from the former mask data by interpolation or data reduction to match the new volume data size. The former mask data is not changed and kept as the original mask data. Accordingly, mismatch that occurs when the volume data is again opened under the former conditions can be eliminated, and loss of information is prevented.

Scaling up or down of the size of the mask data is executed by referencing the volume data. Since the mask data usually is binary, if interpolation or reduction is thoughtlessly executed, the image quality is remarkably degraded. By referencing the volume data, more desirable mask data can be reconstructed.

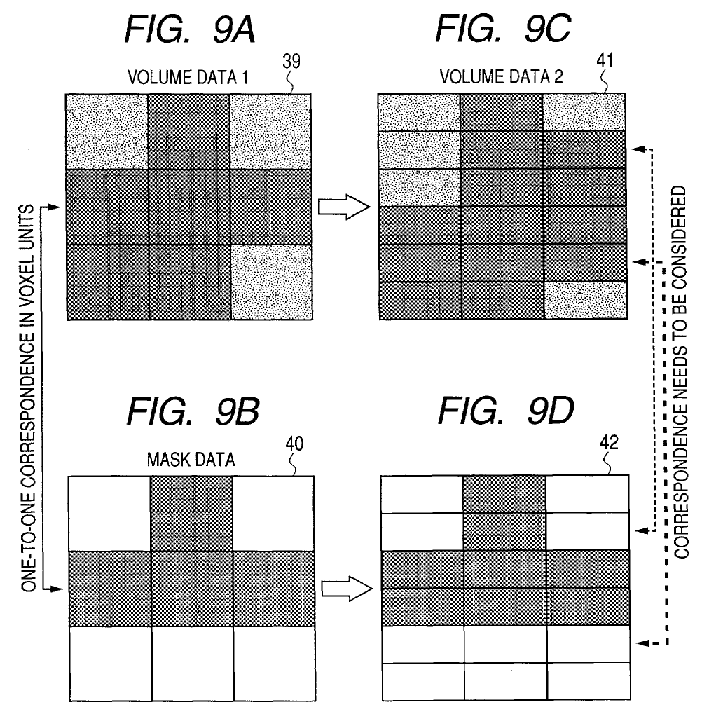

FIGS. 9A-9S, 10A-10F, and 11A-11F are drawings to describe examples wherein mask data cannot easily be adjusted when a mismatch between volume data and mask data exists (a case 2 where they differ in interpolation spacing). FIG. 9A shows volume data (1) 39, and FIG. 9B shows mask data 40 corresponding to the volume data (1) 39. Since the mask data 40 is in a one-to-one correspondence with the volume data (1) 39 in voxel units, the correspondence of volume data (2) 41, which is different from the volume data (1) 39 in interpolation spacing as shown in FIG. 9C, with mask data 42 (FIG. 9D) needs to be considered.

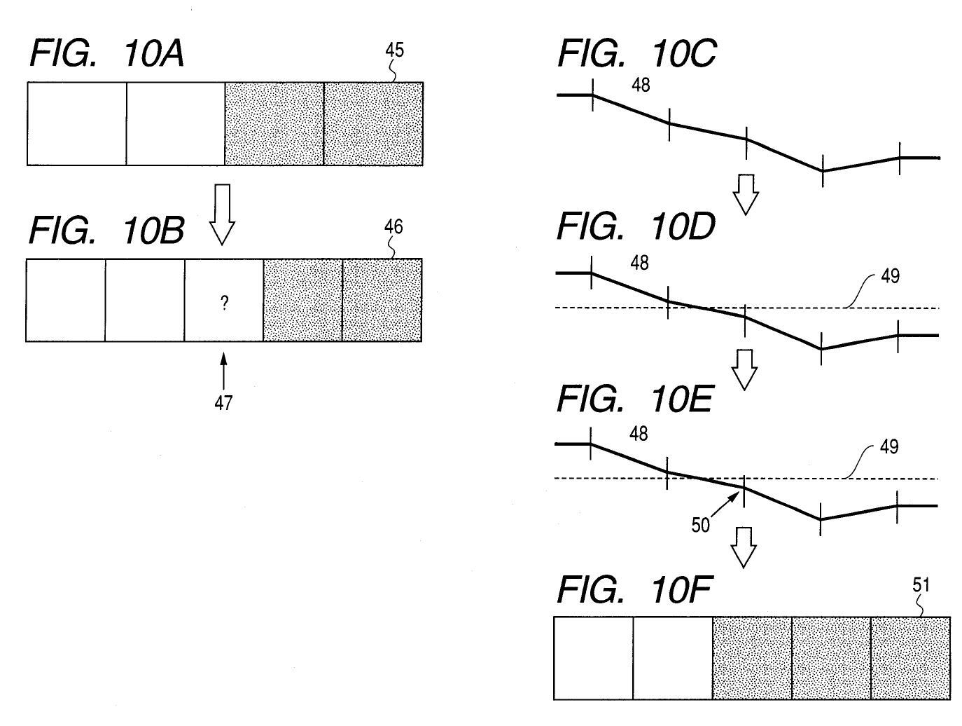

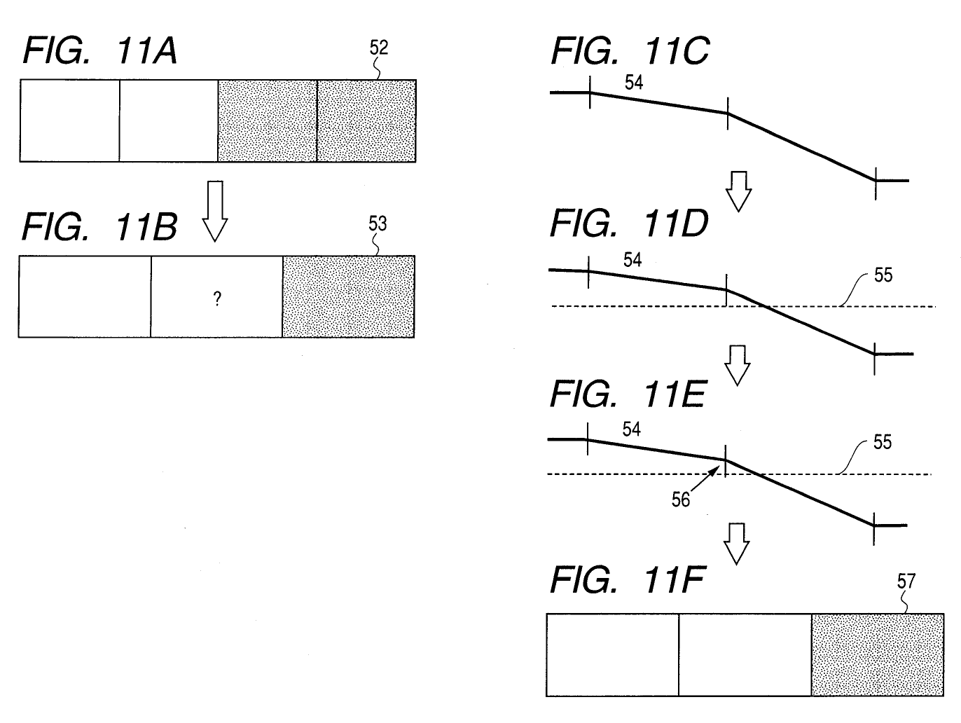

In this case, as shown in FIG. 1A, mask data 45 is binary, and thus it is not preferred to thoughtlessly perform interpolation. For example, as shown in FIG. 10B, the mask value at a point 47 where the mask value makes a transition largely affects the image to be created.

Then, in the embodiment, in a case where the voxel value of corresponding volume data 48 changes as shown in FIG. 10C, an average value 49 of the voxel values in the neighbor of the voxel value corresponding to the point 47 where the mask value makes the transition is acquired as shown in FIG. 10D. Then, it is determined to which region the voxel value of a transition part 50 is closer as shown in FIG. 10E, and mask data 51 is adjusted as shown in FIG. 10F. In a medical image, mask is often a result of region extraction of a tissue, and thus estimation that voxels belonging to the same tissue have close voxel values holds.

Similar comments are applied to the case of reduction. That is, mask data 52 shown in FIG. 11A is binary and thus it is not preferred to thoughtlessly perform interpolation. For example, as shown in FIG. 11B, the mask value at a point where the mask value makes a transition largely affects the image to be created.

Then, in the embodiment, when the voxel value of corresponding volume data 54 changes as shown in FIG. 11C, an average value 55 of the voxel values in the neighbor of the voxel value corresponding to the point where the mask value makes the transition is acquired as shown in FIG. 11D. Then, it is determined to which region the voxel value of a transition part 56 is closer as shown in FIG. 11E, and mask data 57 is adjusted as shown in FIG. 11F.

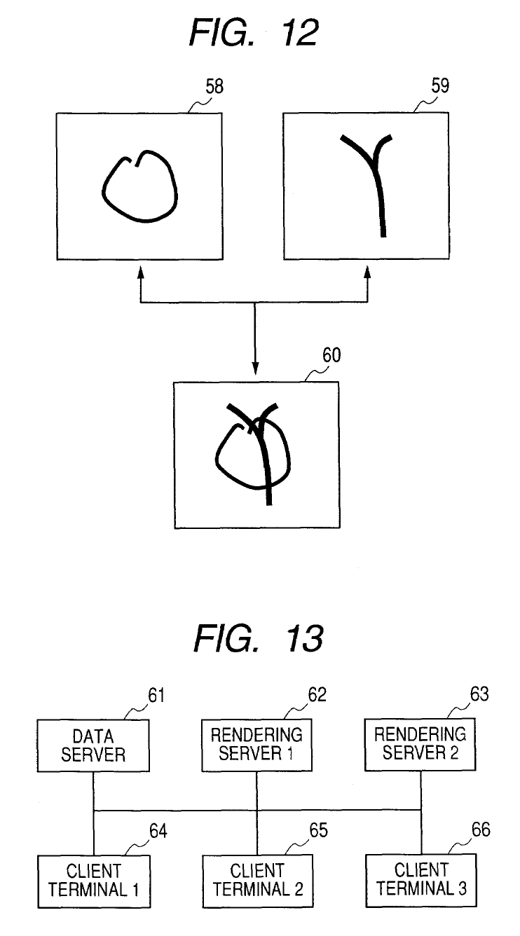

FIG. 12 is a schematic representation for handling a fusion image in the image processing method of the embodiment. The fusion image is an image created from volume data that is created based on a plurality of sets of slice data which are created under different conditions. Usually, a plurality of three-dimensional arrays is respectively created from a plurality of sets of slice data, and volume rendering is executed for the respective three-dimensional arrays at the same time. FIG. 12 shows the case where a fusion image 60 is created from slice data 58 representing the outer shape of an organ and slice data 59 representing a blood stream passing through the organ by way of example. In the embodiment, to create the fusion image 60 after performing processing with volume data containing only the slice data 58 among two sets of slice data, the parameters involved in the later added slice data 59 are initialized using the parameters related to the volume data containing only the slice data 58. Then, the independent parameters are copied, and the dependent parameters are made so that difference between the two sets of slice data becomes distinctive. For example, a color LUT is set so that the portion involved in the former slice data 58 is rendered in red, and a color LUT is set so that the portion involved in the added slice data 59 is rendered in blue.

To display only one set of volume data after creating the fusion image 60, in the embodiment, only the independent and dependent parameters used with the one set of volume data may be used.

FIG. 13 is a diagram to describe the system configuration of an image processing apparatus according to the embodiment of the invention. The image processing apparatus of the embodiment includes a data server 61, a rendering server (1) 62, a rendering server (2) 63, a client terminal (1) 64, a client terminal (2) 65, and a client terminal (3) 66. Each rendering server is an image processing apparatus for mainly performing image processing upon reception of an instruction from the client terminal, and is placed on a network.

In the embodiment, image processing is performed by the high-performance rendering servers (1) 62 and (2) 63. Distributed processing may be performed by using a plurality of the rendering servers (1) 62 and (2) 63. Distributed processing may be performed by using the client terminals (1) 64, (2) 65, and (3) 66 and the rendering servers (1) 62 and (2) 63. In this case, performance remarkably differs particularly depending on a combination of computers on which processing load is placed, and thus the invention is effective.

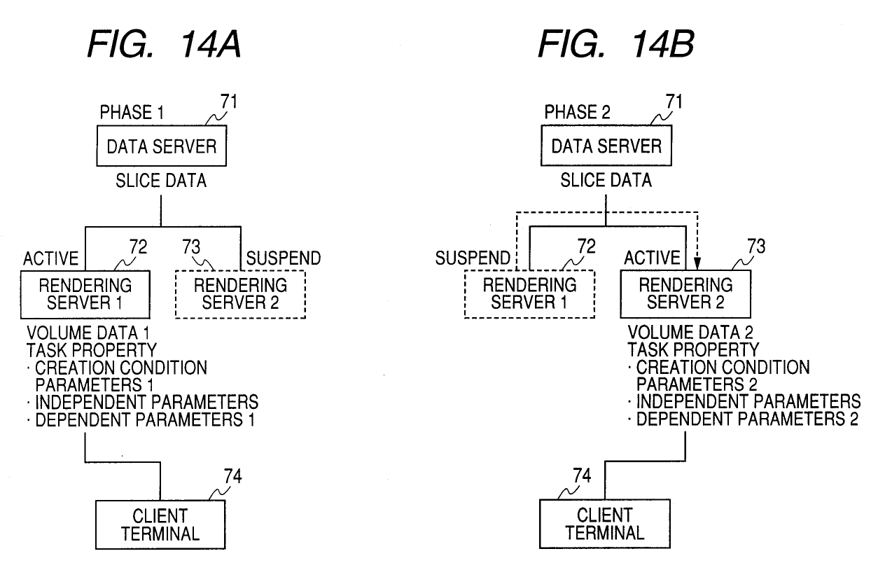

FIGS. 14A and 14B are drawings to describe an image processing flow of the embodiment (rendering server switching) In the image processing method of the embodiment, in phase 1 shown in FIG. 14A, a rendering server (2) 73 is suspended, and when a rendering server (1) 72 is active and performs image processing, the rendering server (1) 72 downloads slice data from a data server 71, creates volume data 1 in response to the performance of the rendering server (1) 72, and also creates creation condition parameters 1 of volume data, independent parameters, and dependent parameters 1 as task property. In the embodiment, the creation condition parameters are determined by the performance of each rendering server and the number of the rendering servers used for calculation.

In phase 2 shown in FIG. 14B, for the rendering server (1) 72 to suspend the image processing, the rendering server (1) 72 transfers the creation condition parameters 1, the independent parameters, and the dependent parameters 1 of the task property to the rendering server (2) 73 which becomes active, and discards the volume data 1 which is the task result.

Next, when the rendering server (2) 73 continues the image processing, the rendering server (2) 73 converts the creation condition parameters 1 and the dependent parameters 1 into creation condition parameters 2 and dependent parameters 2 or creates creation condition parameters 2 and dependent parameters 2 in response to the performance of the rendering server (2) 73, and creates volume data 2. In this case, the rendering server (2) 73 uses the difference between the creation condition parameters 2 and the creation condition parameters 1 to create the dependent parameters 2 from the dependent parameters 1.

### EXAMPLE 1

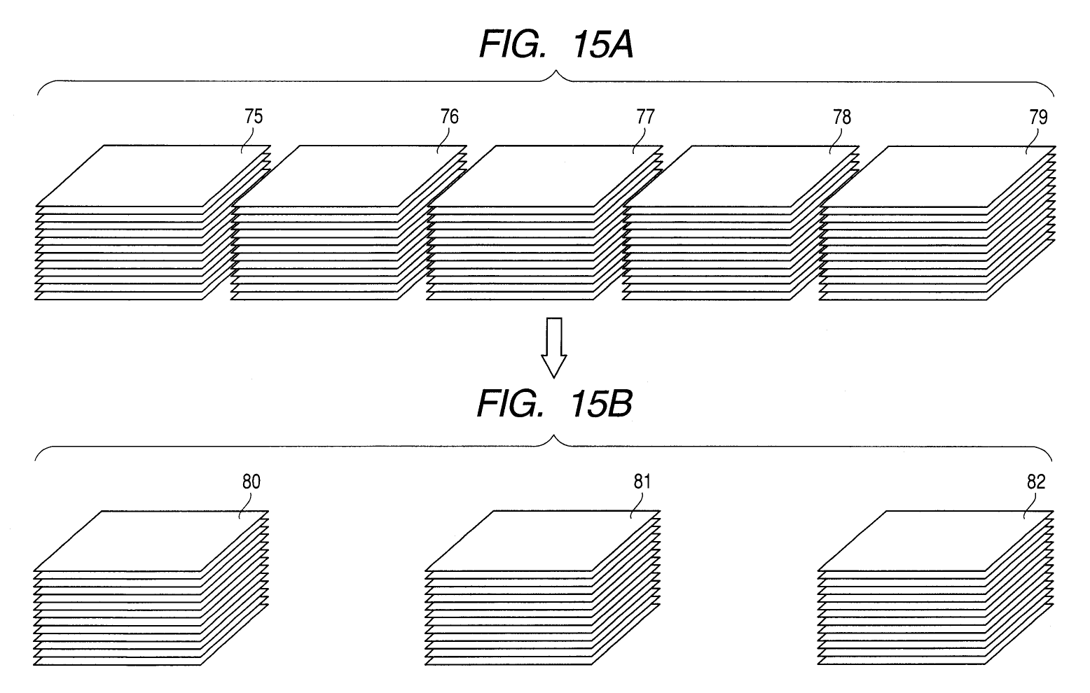

FIGS. 15A and 15B show an example 1 wherein plurality of three-dimensional arrays are retained when four-dimensional or more information exists in the image processing method of the embodiment. Since volume data is implemented mainly as a three-dimensional array made up of a set of slice data, when four-dimensional or more information exists, the volume data is operated in the form of holding a plurality of three-dimensional arrays. The example includes a moving image in time sequence, a plurality of three-dimensional arrays that corresponds to diastolic and contract periods of a heart, which is not necessarily in time sequence, and the like.

That is, 4D data shown in FIG. 15A is operated in the form of holding a plurality of three-dimensional arrays 75, 76, 77, 78, and 79. At this time, all of the three-dimensional arrays 75, 76, 77, 78, and 79 are used to create volume data for performing the task. As shown in FIG. 15B, later, by using only the three-dimensional arrays 75, 77, and 79 that contain important information for diagnosis, a plurality of three-dimensional arrays 80, 81, and 82 can be used to create volume data to resume the task. In this case, the mask, which is a dependent parameter, can be created by applying a method that previously described with reference to FIGS. 10A-10F and 11A-11F, to a time sequence direction in plurality of three-dimensional arrays. This is effective in a computer that has difficulty in handling a large number of sets of three-dimensional data. For example, in the diastolic and contract periods of a heart, the maximum diastolic period and the minimum contract period are important for diagnosis and thus such processing is effective.

### EXAMPLE 2

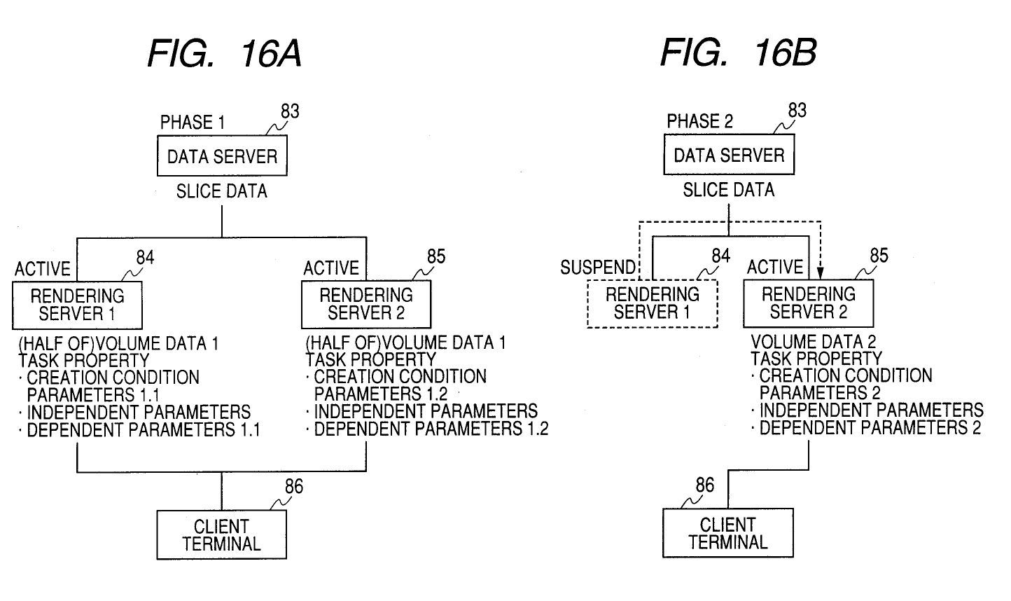

FIGS. 16A and 16B are drawings to describe an image processing flow of the embodiment (for dealing with change of available rendering server). In the image processing method of the embodiment, in phase 1 shown in FIG. 16A, both of a rendering server (1) 84 and a rendering server (2) 85 are active and perform image processing as distributed processing.

That is, the rendering server (1) 84 downloads slice data from a data server 83, creates (a half of) volume data 1 in response to the performance of the rendering server (1) 84, and also creates creation condition parameters 1.1, independent parameters, and dependent parameters 1.1 as task property.

Likewise, the rendering server (2) 85 downloads slice data from the data server 83, creates (a half of) volume data 1 in response to the performance of the rendering server (2) 85, and also creates creation condition parameters 1.2, independent parameters, and dependent parameters 1.2 as task property.

In phase 2 shown in FIG. 16B, for the rendering server (1) 84 to suspend the image processing, the rendering server (1) 84 transfers the creation condition parameters 1.1 and the dependent parameters 1.1 of the task property to the rendering server (2) 85 and discards (the half of) the volume data 1, which is the task result.

The active rendering server (2) 85 continues the image processing, and converts the creation condition parameters 1.1 and 1.2 and the dependent parameters 1.1 and 1.2 into creation condition parameters 2 and dependent parameters 2 or creates creation condition parameters 2 and dependent parameters 2 in response to the performance of the rendering server (2) 85, and creates volume data 2.

Thus, according to the image processing method according to the embodiment, for example, even in a case where the first volume data created by the first rendering server is processed by the second rendering server which is different from the first rendering server in performance, the second dependent parameters matching the performance of the second rendering server are created, whereby the image processing can be continued.

### EXAMPLE 3

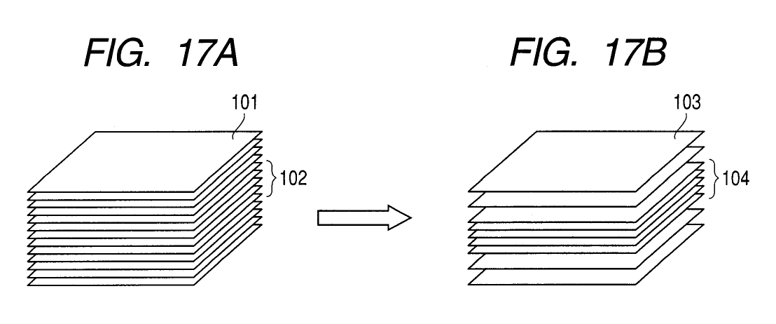

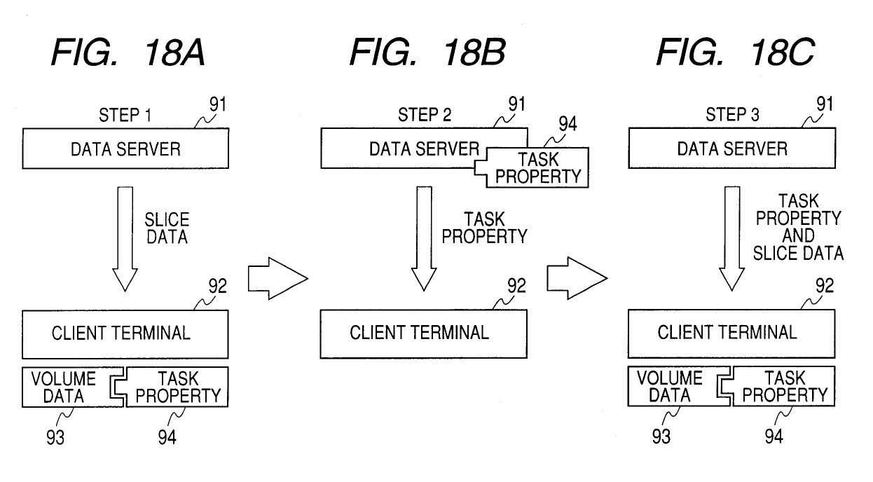

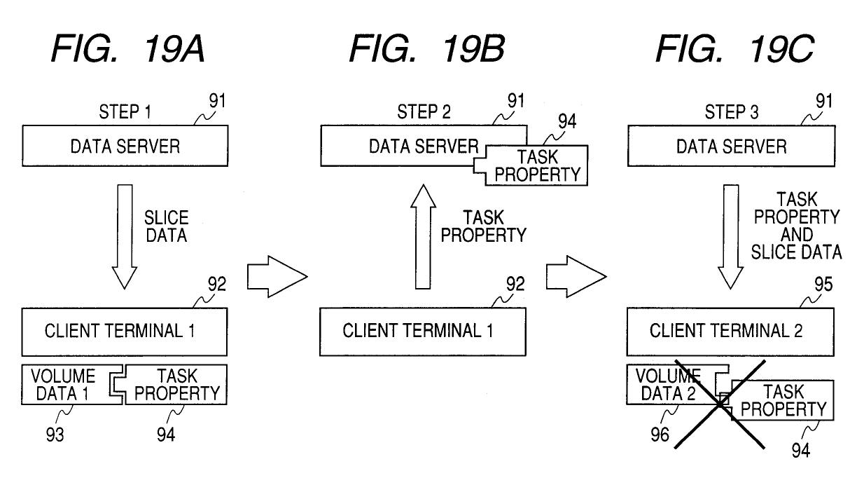

FIGS. 17A and 17B are drawings to describe an image processing flow of the embodiment (for improving precision of important part). In the image processing method of the embodiment, it is assumed that in phase 1 shown in FIG. 17A, volume data 101 is created to perform the task and it turns out that the lesion part is in the range indicated by 102. At this time, the range of the lesion part is recorded in task property as an independent parameter.

Later, when volume data 103 is created in phase 2 shown in FIG. 17B, while a range 104 corresponding to the range 102 can be generated in high resolution, other ranges can be generated in low resolution.

Thus, according to the image processing method according to the embodiment, in the second or later task, the previous task result can be used to create volume data, so that the task can be resumed in a state in which the computation resources are optimized for representation of the important part, and thus the computation resources can be used efficiently.

In each embodiment of the invention, volume data is created from the slice data stored in the data server, but the slice data may be stored in the data server after once converted into the form of volume data. In this case, new volume data is created from the stored volume data. This mode is effective when processing of extracting a lesion part or filtering for highlighting some feature is performed with respect to the volume data before the image processing by a user is performed, for example.

In each embodiment of the invention, the mask data is binary, but may be multivalued. For example, when a transition is made to a client terminal having a poor performance after multivalued mask data is created, binary mask data can be created from the multivalued mask data for resuming the task.

In each embodiment of the invention, the case where the client terminal or the rendering server is changed is illustrated, but the invention can also be applied to the case where the task is resumed in the same client terminal or rendering server. For example, although the computation resources assigned to the task property itself are poor when the task property is created through image analysis processing requiring large computational effort, the computation resources can be concentrated on the task property when the task is later resumed, because the image analysis processing is completed.

The invention can be used as the image processing method capable of suspending and resuming image processing even if the volume data varies depending on the performance of the client terminal.

The embodiment of the invention can be also achieved by a computer readable medium in which a program code (an executable program, an intermediate code program, and a source program) according to the above described image processing method is stored so that a computer can read it, and by allowing the computer (or a CPU or an MCU) to read out the program (software) stored in the storage medium and to execute it.

The computer readable medium includes, for example, a tape-type medium, such as a magnetic tape or a cassette tape, a disc-type medium including a magnetic disc, such as a floppy® disc or a hard disc, and an optical disc, such as CD-ROM/MO/MD/DVD/CD-R, a card-type medium, such as an IC card (including a memory card) or an optical card, and a semiconductor memory, such as a mask ROM, an EPROM, an EEPROM, or a flash ROM.

Further, the computer may be constituted such that it can be connected to a communication network, and the program may be supplied thereto through the communication network. The communication network includes, for example, the Internet, the Intranet, an intranet, an extranet, a LAN, an ISDN, a VAN, a CATV communication network, a virtual private network, telephone lines, a mobile communication network, and a satellite communication network. A transmission medium for constituting the communication network includes, for example, wire lines, such as IEEE1394, USB, power lines, cable TV lines, telephone lines, and ADSL lines, infrared rays, such as IrDA or a remote controller, and wireless lines, such as Bluetooth®, 802.11 Wireless, HDR, a mobile communication network, satellite lines, and a terrestrial digital broadcasting network. In addition, the program may be incorporated into carrier waves and then transmitted in the form of computer data signals.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. An image processing method using volume data, said image processing method comprising:
creating first volume data from slice data based on a first creation condition parameter;
creating an independent parameter and a first dependent parameter from a task property for the first volume data;
obtaining a second dependent parameter from the first dependent parameter based on a second creation condition parameter and the first creation condition parameter;
creating second volume data from at least one of the slice data or data based on the slice data, based on the second creation condition parameter; and
creating a task property for the second volume data based on the independent parameter and the second dependent parameter.

2. The image processing method as claimed in claim 1, wherein the second volume data is created by changing a data size of the first volume data.

3. The image processing method as claimed in claim 1, wherein at least one of the first volume data or the second volume data is created from a plurality of sets of said slice data used for making a fusion image.

4. The image processing method as claimed in claim 1, wherein at least one of the first volume data or the second volume data is four-dimensional data.

5. The image processing method as claimed in claim 1, wherein the first dependent parameter includes mask data.

6. The image processing method as claimed in claim 1, wherein at least one rendering server is used for image rendering.

7. The image processing method as claimed in claim 6, wherein at least one of the first volume data and the second volume data is subjected to distributed processing in a plurality of said rendering servers.

8. A computer readable medium having a program including instructions for permitting a computer to execute image processing for volume data, the instructions comprising:
creating first volume data from slice data based on a first creation condition parameter;
creating an independent parameter and a first dependent parameter from a task property for the first volume data;
obtaining a second dependent parameter from the first dependent parameter based on a second creation condition parameter and the first creation condition parameter;
creating second volume data from at least one of the slice data or data based on the slice data, based on the second creation condition parameter; and
creating a task property for the second volume data based on the independent parameter and the second dependent parameter.

9. An image processing system, comprising:
a data server for storing slice data; and
a first client terminal and a second client terminal,
wherein when the first client terminal is active and is to perform image processing, the first client terminal downloads the slice data from the data server so as to create first volume data based on first creation condition parameter, and creates an independent parameter and a first dependent parameter from a first task property for the first volume data,
the first client terminal transmits the first task property including the first creation condition parameter, the independent parameter and the first dependent parameter to the data server, before the first client terminal suspends processing, and
when the second client terminal is active and is to perform the image processing, the second client terminal downloads the slice data and the first task property including the first creation condition parameter, the independent parameter and the first dependent parameter to the data server, creates a second creation condition parameter and a second dependent parameter from the first creation condition parameter and the first dependent parameter according to performance of the second client terminal, creates second volume data from the slice data based on the second creation condition parameter, and creates a second task property for the second volume data based on the independent parameter and the second dependent parameter.
